(19) United States
(12) Patent Application Publication
(10) Pub. No.: US 2024/0247084 A1
(43) Pub. Date: Jul. 25, 2024

(54) HYDROCARBON SOLUBLE BORATE COCATALYSTS FOR OLEFIN POLYMERIZATION

(71) Applicant: Dow Global Technologies LLC, Midland, MI (US)

(72) Inventors: David M. Pearson, Lake Jackson, TX (US); Cole A. Witham, Pearland, TX (US)

(73) Assignee: Dow Global Technologies LLC, Midland, MI (US)

(21) Appl. No.: 18/690,474

(22) PCT Filed: Sep. 9, 2022
(86) PCT No.: PCT/US2022/076188

§ 371 Date: Mar. 8, 2024

Related U.S. Application Data
(60) Provisional application No. 63/242,749, filed on Sep. 10, 2021.

(51) Int. Cl. C08F 4/52

(52) U.S. Cl. CPC C08F 4/52

(57) ABSTRACT

Embodiments are directed to catalyst systems comprising a metal-ligand complex procatalyst, a Lewis base, and an activator, wherein the activator comprises an anion and a cation, the anion having a structure according to formula (I).

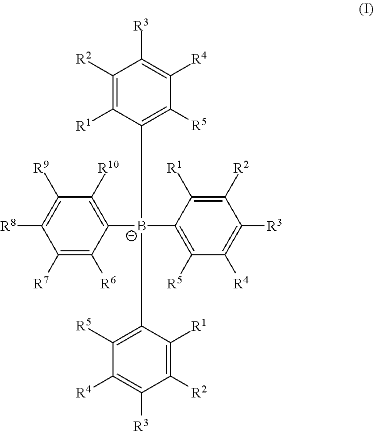

### CROSS-REFERENCE TO RELATED APPLICATION

This application claims the benefit of U.S. Provisional Application Ser. No. 63/242,749 filed Sep. 10, 2021, the entire disclosure of which is hereby incorporated herein by reference.

### TECHNICAL FIELD

Embodiments of the present disclosure generally relate to borate anionic co-catalysts.

### BACKGROUND

Since the discovery of Ziegler and Natta on heterogeneous olefin polymerizations, global polyolefin production reached approximately 150 million tons per year in 2015, and it is rising due to increasing market demand. This success is based in part on a series of important breakthroughs in co-catalyst technology. The co-catalysts discovered include aluminoxanes, boranes, and borates with triphenylcarbenium or ammonium cations. These co-catalysts activate homogeneous single-site olefin polymerization catalysts, and polyolefins have been produced using these co-catalysts in industry.

Borate based co-catalysts in particular have contributed significantly to the fundamental understanding of olefin polymerization mechanisms and have enhanced the ability for precise control over polyolefin microstructures by deliberately tuning catalyst structures and processes. This results in stimulated interest in mechanistic studies and lead to the development of novel homogeneous olefin polymerization catalyst systems that have precise control over polyolefin microstructures and performance.

As part of conventional olefin polymerization catalyst system, the molecular polymerization procatalyst is activated to generate the catalytically active species for polymerization, and this can be achieved by any number of means. One such method employs an activator or co-catalyst that is a Brønsted acid. Brønsted acid salts containing weakly coordinating anions are commonly utilized to activate molecular polymerization procatalysts, particularly such procatalysts comprising Group IV metal complexes. Generally, the Brønsted acid salts include a borate or an aluminate salt.

### SUMMARY

Despite the unique properties of the molecular catalyst systems that combine borate co-catalyst and Ziegler-Natta procatalyst, the molecular catalyst systems are not easily solubilized in non-aromatic, apolar solvents, such as heptane or methylcyclohexane. Since ethylene and other olefins are often commercially polymerized in apolar solvents the procatalyst and co-catalyst components must also be delivered in such solvents. If the procatalyst or co-catalyst is insoluble, they can be delivered as a slurry, but these systems often require additional equipment and present unique complications for their delivery in solution processes. Alternatively, if these components have low solubility in the solvent, they will inherently require larger volumes of solvent to transport and deliver a given molar quantity, making transportation more difficult. Ultimately such remedies can result in the activity of the catalyst system being greatly decreased as well due to issues related to contamination which scale with dilution. Furthermore, it is preferred that catalyst component remain soluble under a variety of conditions. So, while solubility may be acceptable at room temperature, lower temperatures may lower the solubility of components, and in extreme cases, may even result in precipitation or biphasic mixtures. As a result, there is an ongoing need to have highly soluble catalyst component systems, especially in apolar solvent across a variety of operating conditions, while maintaining catalyst efficiency, reactivity, and the ability to produce polymers with good physical properties.

In embodiments, an activator complex includes a Lewis base and an activator, wherein the activator comprises an anion and a cation, the anion having a structure according to formula (I):

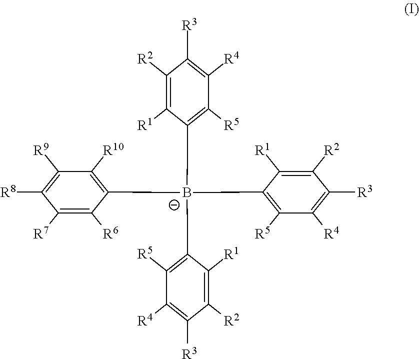

In formula (I), B is boron atom. Each R¹ and each R⁵ is selected from —H or —F; each R², R³, and R⁴ is selected from —H, —F, (C₁-C₁₀)hydrocarbyl, (C₁-C₁₀)heterohydrocarbyl; R⁶, R⁷, R⁸, R⁹, and R¹⁰ are independently selected from —H, —F, (C₁-C₁₀)hydrocarbyl, (C₁-C₁₀)heterohydrocarbyl, —OR^{C}, —SiR^{C}₃, wherein R^{C} is —H or (C₁-C₁₀)hydrocarbyl, and optionally R⁷ and R⁸ are connected to form a ring.

In the activator complex, the Lewis Base has a structure according to formula (II):

M₂R^{N1}R^{N2}R^{N3} (II)

In formula (II), M₂ is nitrogen or phosphorous; and R^{N1} is (C₁-C₃₀)hydrocarbyl, R^{N2} is (C₂-C₃₀)hydrocarbyl, and R^{N3} is (C₃-C₃₀)hydrocarbyl.

### DETAILED DESCRIPTION

Specific embodiments of catalyst systems will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

Common abbreviations are listed below:

Me: methyl; Et: ethyl; Ph: phenyl; Bn: benzyl; i-Pr: iso-propyl; t-Bu: tert-butyl; t-Oct: tert-octyl (2,4,4-trimethylpentan-2-yl); Tf: trifluoromethane sulfonate; THF: tetrahydrofuran; Et₂O: diethyl ether; CH₂Cl₂: dichloromethane; CV: column volume (used in column chromatography); EtOAc: ethyl acetate; C₆D₆: deuterated benzene or benzene-d6 CDCl₃: deuterated chloroform; Na₂SO₄: sodium sulfate; MgSO₄: magnesium sulfate; HCl: hydrogen chloride; n-BuLi: butyllithium; t-BuLi: tert-butyllithium; MAO: methylaluminoane; MMAO: modified methylaluminoxane; GC: gas chromatography; LC: liquid chromatography; NMR: nuclear magnetic resonance; MS: mass spectrometry; mmol: millimoles; mL: milliliters; M: molar; min or mins: minutes; h or hrs: hours; d: days.

The term “independently selected” is used herein to indicate that the R groups, such as, R¹, R², R³, R⁴, and R⁵, can be identical or different (e.g., R¹, R², R³, R⁴, and R⁵ may all be substituted alkyls or R¹ and R² may be a substituted alkyl and R³ may be an aryl, etc). A chemical name associated with an R group is intended to convey the chemical structure that is recognized in the art as corresponding to that of the chemical name. Thus, chemical names are intended to supplement and illustrate, not preclude, the structural definitions known to those of skill in the art.

The term “procatalyst” refers to a transition metal compound that has olefin polymerization catalytic activity when combined with an activator. The term “activator” refers to a compound that chemically reacts with a procatalyst in a manner that converts the procatalyst to a catalytically active species. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom of a corresponding unsubstituted compound or functional group is replaced by a substituent (e.g. R^{S}). The term “—H” means a hydrogen or hydrogen radical that is covalently bonded to another atom. “Hydrogen” and “—F” are interchangeable, and unless clearly specified have identical meanings.

The term “(C₁-C₅₀)hydrocarbyl” means a hydrocarbon radical of from 1 to 50 carbon atoms and the term “(C₁-C₅₀)hydrocarbylene” means a hydrocarbon diradical of from 1 to 50 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted.

In this disclosure, a (C₁-C₅₀)hydrocarbyl may be an unsubstituted or substituted (C₁-C₅₀)alkyl, (C₃-C₅₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene (such as benzyl (—CH₂-C₆H₅)).

The term “(C₁-C₅₀)alkyl” means a saturated straight or branched hydrocarbon radical containing from 1 to 50 carbon atoms; and the term “(C₁-C₃₀)alkyl” means a saturated straight or branched hydrocarbon radical of from 1 to 30 carbon atoms. Each (C₁-C₅₀)alkyl and (C₁-C₃₀)alkyl may be unsubstituted or substituted by one or more R^{S}. In some examples, each hydrogen atom in a hydrocarbon radical may be substituted with R^{S}, such as, for example trifluoromethyl. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅alkyl, such as, for example, methyl, trifluoromethyl, ethyl, 1-propyl, I-methylethyl, or 1,1-dimethylethyl.

The term (C₃-C₅₀)alkenyl means a branched or unbranched, cyclic or acyclic monovalent hydrocarbon radical containing from 3 to 50 carbon atoms, at least one double bond and is unsubstituted or substituted by one or more R^{S}. Examples of unsubstituted (C₃-C₅₀)alkenyl: n-propenyl, isopropenyl, n-butenyl, isobutenyl, octenyl, decenyl, cyclopentenyl, cyclopentadienyl, cyclohexenyl, and cyclohexadienyl. Examples of substituted (C₃-C₅₀)alkenyl: (2-trifluoromethyl)pent-1-enyl, (3-methyl)hex-1-eneyl, (3-methyl)hexa-1,4-dienyl and (Z)-1-(6-methylhept-3-en-1-yl)cyclohex-1-eneyl.

The term “(C₆-C₅₀)aryl” means an unsubstituted or substituted (by one or more R^{S}) monocyclic, bicyclic, or tricyclic aromatic hydrocarbon radical of from 6 to 40 carbon atoms, of which at least from 6 to 14 of the carbon atoms are aromatic ring carbon atoms. A monocyclic aromatic hydrocarbon radical includes one aromatic ring; a bicyclic aromatic hydrocarbon radical has two rings; and a tricyclic aromatic hydrocarbon radical has three rings. When the bicyclic or tricyclic aromatic hydrocarbon radical is present, at least one of the rings of the radical is aromatic. The other ring or rings of the aromatic radical may be independently fused or non-fused and aromatic or non-aromatic. Examples of unsubstituted (C₆-C₅₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; substituted (C₆-C₁₈)aryl; 2,4-bis([C₂₀]alkyl)-phenyl; polyfluorophenyl; pentafluorophenyl; and fluoren-9-one-1-yl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₁₀)cycloalkyl are substituted (C₃-C₂₀)cycloalkyl, substituted (C₃-C₁₀)cycloalkyl, and 1-fluorocyclohexyl.

The term “heteroatom,” refers to an atom other than hydrogen or carbon. Examples of groups containing one or more than one heteroatom include O, S, S(O), S(O)₂, Si(R^{C})₂, P(R^{P}) N(R^{N}), —N═C(R^{C})₂, —Ge(R^{C})₂—, —Si(R^{C})—, boron (B), aluminum (Al), gallium (Ga), or indium (In), where each R^{C} and each R is unsubstituted (C₁-C₁₈)hydrocarbyl or —H, and where each R^{N} is unsubstituted (C₁-C₁₈)hydrocarbyl. The term “heterohydrocarbon” refers to a molecule or molecular framework in which one or more carbon atoms of a hydrocarbon are replaced with a heteroatom. The term “(C₁-C₅₀)heterohydrocarbyl” means a heterohydrocarbon radical of from 1 to 50 carbon atoms, and the term “(C₁-C₁₀)heterohydrocarbylene” means a heterohydrocarbon diradical of from 1 to 50 carbon atoms. The heterohydrocarbon of the (C₁-C₅₀)heterohydrocarbyl or the (C₁-C₅₀)heterohydrocarbylene has one or more heteroatoms. The radical of the heterohydrocarbyl may be on a carbon atom or a heteroatom. The two radicals of the heterohydrocarbylene may be on a single carbon atom or on a single heteroatom. Additionally, one of the two radicals of the diradical may be on a carbon atom and the other radical may be on a different carbon atom; one of the two radicals may be on a carbon atom and the other on a heteroatom; or one of the two radicals may be on a heteroatom and the other radical on a different heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₅₀)heterohydrocarbyl may be unsubstituted or substituted. Non-limiting examples of the (C₁-C₅₀)heterohydrocarbyl include (C₁-C₅₀)heteroalkyl, (C₁-C₅₀)hydrocarbyl-O—, (C₁-C₅₀)hydrocarbyl-S—, (C₁-C₅₀)hydrocarbyl-S(O)—(C₁-C₅₀)hydrocarbyl-S(O)₂—, (C₁-C₅₀)hydrocarbyl-Si(R^{C})₂—, (C₁-C₅₀)hydrocarbyl-N(R^{N})—, (C₁-C₅₀)hydrocarbyl-P(R^{P})—, (C₂-C₅₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂)heteroalkylene, (C₁-C₅₀)heteroaryl, (C₁-C₁₉)heteroaryl-(C₁-C₂₀)alkylene, (C₆-C₂₀)aryl-(C₁-C₁₉)heteroalkylene, or (C₁-C₉)heteroaryl-(C₁-C₂₀)heteroalkylene.

The term “(C₁-C₅₀)heteroaryl” means an unsubstituted or substituted (by one or more R^{S}) mono-, bi-, or tricyclic heteroaromatic hydrocarbon radical of from 1 to 50 total carbon atoms and from 1 to 10 heteroatoms. A monocyclic heteroaromatic hydrocarbon radical includes one heteroaromatic ring; a bicyclic heteroaromatic hydrocarbon radical has two rings; and a tricyclic heteroaromatic hydrocarbon radical has three rings. When the bicyclic or tricyclic heteroaromatic hydrocarbon radical is present, at least one of the rings in the radical is heteroaromatic. The other ring or rings of the heteroaromatic radical may be independently fused or non-fused and aromatic or non-aromatic. Other heteroaryl groups (e.g., (Cₓ-C_{y})heteroaryl generally, such as (C₁-C₁₂)heteroaryl) are defined in an analogous manner as having from x to y carbon atoms (such as 1 to 12 carbon atoms) and being unsubstituted or substituted by one or more than one R^{S}. The monocyclic heteroaromatic hydrocarbon radical is a 5-membered ring or a 6-membered ring. The 5-membered ring monocyclic heteroaromatic hydrocarbon radical has 5 minus h carbon atoms, where b is the number of heteroatoms and may be 1, 2, 3, or 4; and each heteroatom may be O, S, N, or P. Examples of 5-membered ring heteroaromatic hydrocarbon radicals include pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring monocyclic heteroaromatic hydrocarbon radical has 6 minus h carbon atoms, where h is the number of heteroatoms and may be 1 or 2 and the heteroatoms may be N or P. Examples of 6-membered ring heteroaromatic hydrocarbon radicals include pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,6,6-ring system is acrydin-9-yl.

The term “(C₁-C₅₀)heteroalkyl” means a saturated straight or branched chain radical containing one to fifty carbon atoms and one or more heteroatom. The term “(C₁-C₅₀)heteroalkylene” means a saturated straight or branched chain diradical containing from 1 to 50 carbon atoms and one or more than one heteroatoms. The heteroatoms of the heteroalkyls or the heteroalkylenes may include Si(R^{C})₃, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or are substituted by one or more R^{S}.

Examples of unsubstituted (C₂-C₄₀)heterocycloalkyl include unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double or triple bonds optionally may be present in substituents R^{S}. The term “unsaturated” means containing one or more carbon-carbon double bonds or carbon-carbon triple bonds, or (in heteroatom-containing groups) one or more carbon-nitrogen double bonds, carbon-phosphorous double bonds, or carbon-silicon double bonds, not including double bonds that may be present in substituents R^{S}, if any, or in aromatic rings or heteroaromatic rings, if any.

Embodiments of this disclosure include an activator complex. The activator complex includes a Lewis base and an activator, wherein the activator comprises an anion and a cation, the anion having a structure according to formula (I):

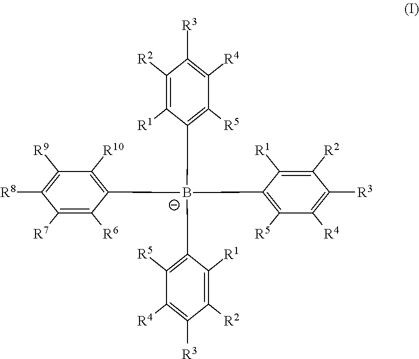

In formula (I), B is boron atom. Each R¹ and each R⁵ is selected from —H or —F; each R², R³, and R⁴ is selected from —H, —F, (C₁-C₁₀)hydrocarbyl, (C₁-C₁₀)heterohydrocarbyl; R⁶, R⁷, R⁸, R⁹, and R¹⁰ are independently selected from —H, —F, (C₁-C₁₀)hydrocarbyl, (C₁-C₁₀)heterohydrocarbyl, —OR^{C}, —SiR^{C}₃, wherein R^{C} is —H or (C₁-C₁₀)hydrocarbyl, and optionally R⁷ and R⁸ are connected to form a ring.

In the activator complex, the Lewis Base has a structure according to formula (II):

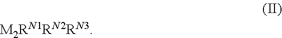

In formula (II), M₂ is nitrogen or phosphorous; and R^{N1} is (C₁-C₃₀)hydrocarbyl, R^{N2} is (C₂-C₃₀)hydrocarbyl, and R^{N3} is (C₂-C₃₀)hydrocarbyl.

In one or more embodiments, in formula (II), R^{N1} may be linear (C₁-C₃₀)alkyl, branched (C₁-C₃₀)alkyl, (C₃-C₃₀)cycloalkyl. In some embodiments, in formula (II), R^{N1} may be methyl, ethyl, propyl, isopropyl, cyclopropyl, n-butyl, isobutyl, cyclobutyl, pentyl, cyclopentyl, hexyl, cyclobexyl, septyl, octyl, nonyl, decyl, undecyl, dodecyl.

In some embodiments, in formula (II), R^{N2} and R^{N3} independently may be (C₁₀-C₃₀)hydrocarbyl. In one or more embodiments, in formula (II), R^{N2} and R^{N3} independently may be linear (C₂-C₃₀)alkyl, branched (C₂-C₃₀)alkyl, (C₃-C₃₀)cycloalkyl. In various embodiments, in formula (II), R^{N2} and R^{N3} independently may be (C₁₀-C₃₀)alkyl, branched (C₁₀-C₃₀)alkyl, (C₃-C₃₀)cycloalkyl. In some embodiments, in formula (II), R^{N2} and R^{N3} independently may be ethyl, propyl, isopropyl, cyclopropyl, n-butyl, isobutyl, cyclobutyl, pentyl, cyclopentyl, hexyl, cyclohexyl, septyl, octyl, nonyl, decyl, undecyl, dodecyl.

In some embodiments, in formula (I), when three or more of R⁶, R⁷, R⁸, R⁹, and R¹⁰ are fluorine atoms, at least one of R¹, R², R³, R⁴, and R⁵ of each individual ring is a —H. In various embodiments, when none of R⁶, R⁷, R⁸, R⁹, and R¹⁰ are fluorine atoms, at least four of R¹, R², R³, R⁴, and R⁵ are fluorine atoms.

In some embodiments, each of R¹, R², R³, R⁴, and R⁵ are fluorine atoms. In some embodiments, each of R², R³, R⁴, and R⁵ are fluorine atoms. In one or more embodiments, R², R³, and R⁴ are fluorine atoms. In various embodiments, R¹, R³, and R⁵ are fluorine atoms. In some embodiments, R² and R⁵ are —CF₃ or fluorine atoms. In one or more embodiments, R², R³, and R⁵ are fluorine atoms.

In one or more embodiments, R⁶, R⁷, R⁸, R⁹, and R¹⁰ are fluorine atoms. In some embodiments, R⁷, R⁸, R⁹, and R¹⁰ are fluorine atoms; or R⁸, and R⁹ are fluorine atoms. In various embodiments, R⁷ and R⁹ are —CF₃. In some embodiments, R⁶ and R¹⁰ are fluorine atoms. In one or more embodiments, R⁶, R⁸, and R¹⁰ are fluorine atoms.

In one or more embodiments, the catalyst system includes less the 1.0 molar equivalent of the Lewis Base based on the molar amount of the activator. In some embodiments, the catalyst system includes less the 0.5 molar equivalent, or less than or equal to 0.2 molar equivalent of the Lewis Base based on the molar amount of the activator.

In various embodiments, the catalyst system includes a molar ratio of the Lewis Base to the activator complex of 0.9:1 to 0.01:1, 0.8:1 to 0.05:1, 0.7:1 to 0.1:1, or 0.6:1 to 0.2:1.

In embodiments, the catalyst system includes an anion of formula (I) and a cation. The cation is any cation having a formal charge of +1. In one or more embodiments, the cation is protic. In some embodiments, the cation may be the protonated structure of formula (II). In some embodiments, the cation is selected from the group consisting of tertiary carbocations, alkyl-substituted ammonium ions, anilinium, alkyl-substituted alumocenium, or ferrocenium.

In some embodiments of the activator, the countercation is chosen from a protonated tri[(C₁-C₄₀)hydrocarbyl] ammonium cation. In some embodiments, the countercation is a protonated trialkylammonium cation, containing one or two (C₁₄-C₂₀)alkyl on the ammonium cation. In one or more embodiments, the countercation is ⁺N(CH₃)HR^{N}₂, wherein R^{N} is (C₁₆-C₁₈)alkyl. In some embodiments, the countercation is chosen from methyldi(octadecyl)ammonium cation or methyldi(tetradecyl)ammonium cation. The methyldi(octadecyl)ammonium cation or methyldi(tetradecyl)ammonium cation are collectively referred to herein as armeenium cations. Ionic compounds having an armeenium cations are from Nouryon under the trade name Armeen™ M2HT. In other embodiments, the countercation is triphenylmethyl carbocation (Ph₃C+), also referred to as trityl. In one or more embodiments, the countercation is a tris-substituted-triphenylmethyl carbocation, such as ⁺C(C₆H₄R^{C})₃, wherein each R^{C} is independently chosen from (C₁-C₃₀)alkyl. In other embodiments, the countercation is chosen from anilinium, ferrocenium, or aluminoceniums. Anilinium cations are protonated nitrogen cations, such as [HMe₂N(C₆H₅)]⁺. Aluminoceniums are aluminum cations, such as R^{S}₂Al(THF)₂⁺, where R^{S} is chosen from (C₁-C₃₀)alkyl.

In some embodiments the catalyst system comprises less the 1.0 molar equivalent of the Lewis Base based on the molar amount of the activator.

In some embodiments, the activator complex includes a molar ratio of the Lewis base to the activator of 0.9:1 to 0.01:1. In one or more embodiments, the activator complex includes a molar ratio of the Lewis base to the activator of 0.05:1 to 0.01:1. In various embodiments, the weight percent of the Lewis base is greater than 10 ppm. In some embodiments, the weight percent of the Lewis base is greater than 100 ppm, greater than 500 ppm, greater than 1,000 ppm, or from 1,000 ppm to greater than 10,000 ppm. In various embodiments, the weight percent of the Lewis base is greater.

The activator complex of this disclosure is formed by addition of the Lewis base to the activator having the anion according to formula (I) prior to contact with a procatalyst and prior to its use in a polymerization process.

The catalyst system of any one of the preceding claims, wherein the total number of fluorine atoms is at least 4. In some embodiments, the total number of fluorine atoms is 4 to 18.

In illustrative embodiments, the catalyst systems may include an activator having an anion and cation, wherein the anion is according to formula (I) and the activator a structure of any:

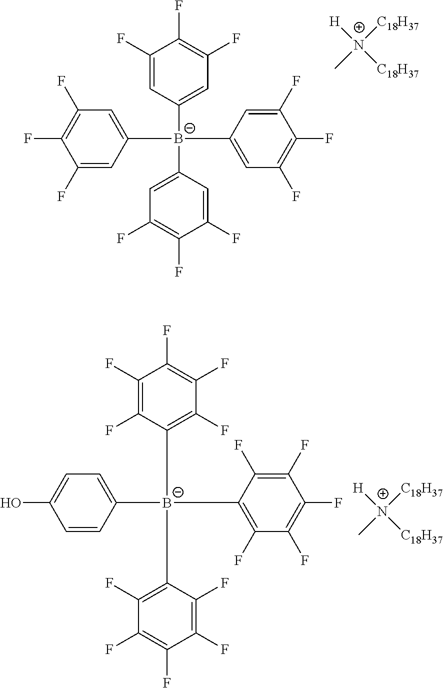

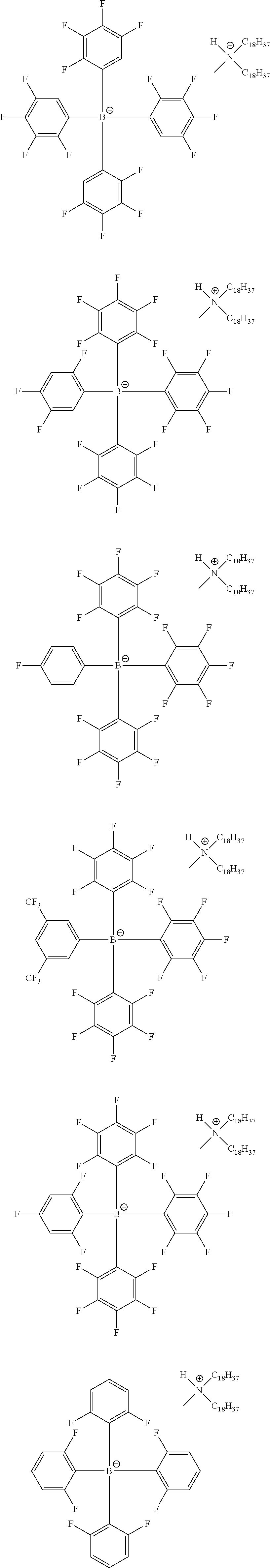

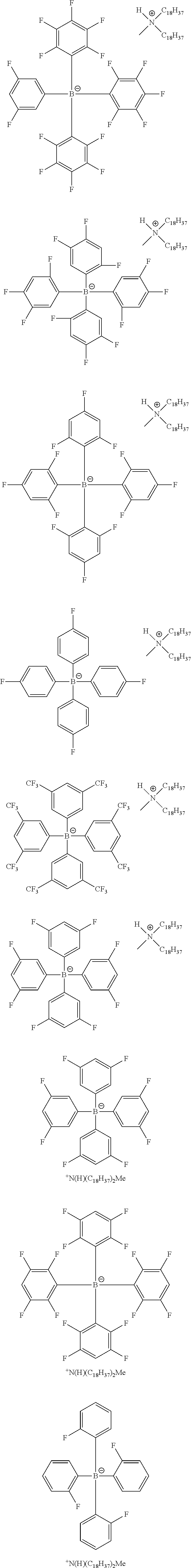

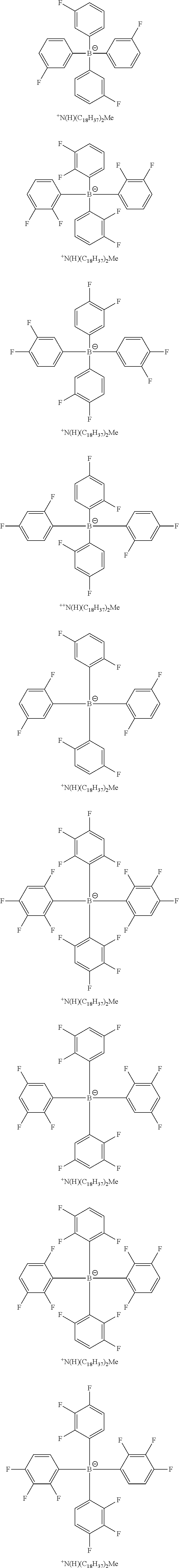

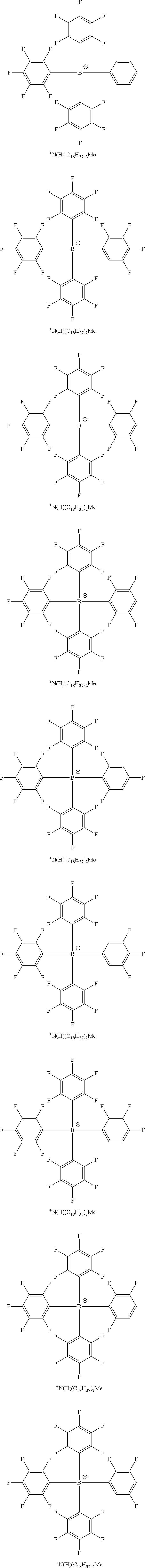

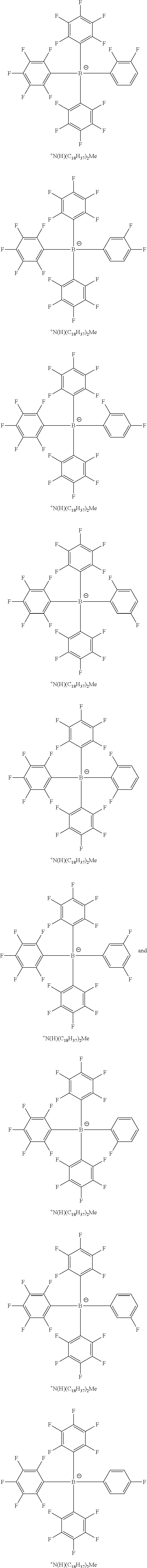

### Catalyst System Components

The catalyst system may include procatalyst. The procatalyst may be rendered catalytically active by contacting the complex to, or combining the complex with, a metallic activator having anion of formula (I) and a countercation. The procatalyst may be chosen from a metal-ligand complex, such as a Group IV metal-ligand complex (Group IVB according to CAS or Group 4 according to IUPAC naming conventions), such as a titanium (Ti) metal-ligand complex, a zirconium (Zr) metal-ligand complex, or a hafnium (Hf) metal-ligand complex. Non-limiting examples of the procatalyst include catalysts, procatalysts, or catalytically active compounds for polymerizing ethylene-based polymers are disclosed in one or more of U.S. Pat. No. 8,372,927; WO 2010022228; WO 2011102989; U.S. Pat. Nos. 6,953,764; 6,900,321; WO 2017173080; U.S. Pat. No. 7,650,930; 6,777,509 WO 99/41294; U.S. Pat. No. 6,869,904; or WO 2007136496, all of which documents are incorporated herein by reference in their entirety.

In one or more embodiments, the catalyst system includes a metal-ligand complex procatalyst, in which the catalyst is ionic. Not intending to be limiting, examples of the homogeneous catalysts include metallocene complexes, constrained geometry metal-ligand complexes (Li, H.; Marks, T. J., Proc. Natl. Acad. Sci. U.S.A 2006, 103, 15295-15302; Li, H.; Li, L.; Schwartz, D. J.; Metz, M. V.; Marks, T. J.; Liable-Sands, L.; Rheingold, A. L., J. Am. Chem. Soc. 2005, 127, 14756-14768; McInnis, J. P.; Delferro, M.; Marks, T. J., Acc. Chem. Res. 2014, 47, 2545-2557; Delferro, M.; Marks, T. J., Chem. Rev. 2011, 111, 2450-2485.), pyridylamido Hf (or Zr, Ti) complexes (Arriola, D. J.; Carnahan, E. M.; Hustad, P. D.; Kuhlman, R. L.; Wenzel, T. T., Science, 2006, 312, 714-719.; Arriola, D. J.; Carnahan, E. M.; Cheung, Y. W.; Devore, D. D.; Graf, D. D.; Hustad, P. D.; Kuhlman, R. L.; Shan, C. L. P.; Poon, B. C.; Roof, G. R., U.S. Pat. No. 9,243,090 B2, 2016.), phenoxyimine metal complexes (Makio, H.; Terao, H.; Iwashita, A.; Fujita, T., Chem. Rev. 2011, 111, 2363-2449.), bis-biphenylphenoxy metal-ligand complexes (Arriola, D. J.; Bailey, B. C.; Klosin, J.; Lysenko, Z.; Roof, G. R.; Smith, A. J. WO2014209927A1, 2014.), etc. The following references summarize metal complexes as olefin polymerization catalysts both in industry and academia: Stürzel, M.; Mihan, S.; Mülhaupt, R., Chem. Rev. 2016, 116, 1398-1433.; Busico, V., Dalton Transactions 2009, 8794-8802.; Klosin, J.; Fontaine, P. P.; Figueroa, R., Acc. Chem. Res. 2015, 48, 2004-2016. All references listed in the detailed description of the present disclosure are incorporated herein.

In one or more embodiments, the Group IV metal-ligand complex includes a bis(phenylphenoxy) Group IV metal-ligand complex or a constrained geometry Group IV metal-ligand complex.

According to some embodiments, the Group IV metal-ligand procatalyst complex may include a bis(phenylphenoxy) structure according to formula (X):

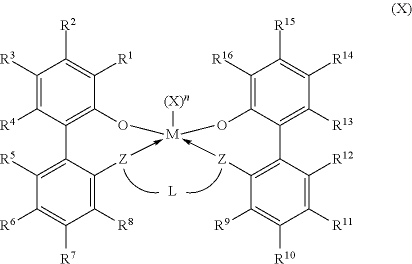

In formula (X), M is a metal chosen from titanium, zirconium, or hafnium, the metal being in a formal oxidation state of +2, +3, or +4. Subscript n of (X)ₙ is 0, 1, or 2. When subscript n is 1, X is a monodentate ligand or a bidentate ligand, and when subscript n is 2, each X is a monodentate ligand. L is a diradical selected from the group consisting of (C₁-C₄₀)hydrocarbylene, (C₁-C₄₀)heterohydrocarbylene, —Si(R^{C})₂—, —Si(R^{C})₂OSi(R^{C})₂—, —Si(R^{C})₂C(R^{C})₂, —Si(R^{C})₂Si(R^{C})₂, —Si(R^{C})₂C(R^{C})₂Si(R^{C})₂, —C(R^{C})₂Si(R^{C})₂C(R^{C})₂—, —N(R^{N})C(R^{C})₂—, —N(R^{N})N(R^{N})—, —C(R^{C})₂N(R^{N})C(R^{C})₂—, —Ge(R^{C})₂—, —P(R^{P})—, —N(R^{N})—, —O—, —S—, —S(O)—, —S(O)₂—, —N═C(R^{C})—, —C(O)O—, —OC(O)—, —C(O)N(R)—, and —N(R^{C})C(O)—. Each Z is independently chosen from —O—, —S—, —N(R^{N})—, or —P(R^{P})—; R²-R⁴, R⁵-R⁻⁸, R⁹-R¹² and R¹³-R¹⁵ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, and halogen. R¹ and R¹⁶ are selected from radicals having formula (XI), radicals having formula (XII), and radicals having formula (XIII):

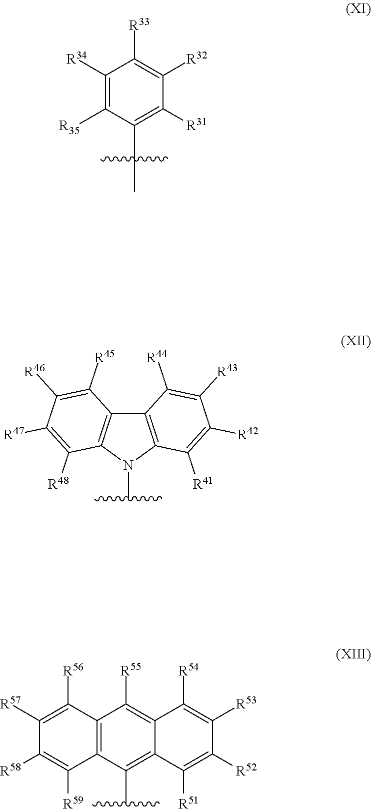

In formulas (XI), (XII), and (XIII), each of R³¹-R³⁵, R⁴¹-R⁴⁸, and R⁵¹-R⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In one or more embodiments, each X can be a monodentate ligand that, independently from any other ligands X, is a halogen, unsubstituted (C₁-C₂₀)hydrocarbyl, unsubstituted (C₁-C₂₀)hydrocarbylC(O)O—, or R^{K}R^{L}N—, wherein each of R^{K} and R^{L} independently is an unsubstituted(C₁-C₂₀)hydrocarbyl

According to some embodiments, the Group IV metal-ligand complex may include a cyclopentadienyl procatalyst according to formula (XIV):

LpᵢMXₘX′ₙX″ₚ, or a dimer thereof (XIV).

In formula (XIV), Lp is an anionic, delocalized, π-bonded group that is bound to M, containing up to 50 non-hydrogen atoms. In some embodiments of formula (XIV), two Lp groups may be joined together forming a bridged structure, and further optionally one Lp may be bound to X.

In formula (XIV), M is a metal of Group 4 of the Periodic Table of the Elements in the +2, +3 or +4 formal oxidation state. X is an optional, divalent substituent of up to 50 non-hydrogen atoms that together with Lp forms a metallocycle with M. X′ is an optional neutral ligand having up to 20 non hydrogen atoms; each X″ is independently a monovalent, anionic moiety having up to 40 non-hydrogen atoms. Optionally, two X″ groups may be covalently bound together forming a divalent dianionic moiety having both valences bound to M, or, optionally two X″ groups may be covalently bound together to form a neutral, conjugated or nonconjugated diene that is π-bonded to M, in which M is in the +2 oxidation state. In other embodiments, one or more X″ and one or more X′ groups may be bonded together thereby forming a moiety that is both covalently bound to M and coordinated thereto by means of Lewis base functionality. Subscript i of Lpᵢ is 0, 1, or 2; subscript n of X′ₙ is 0, 1, 2, or 3; subscript m of Xₘ is 0 or 1; and subscript p of X″ₚ is 0, 1, 2, or 3. The sum of i+m+p is equal to the formula oxidation state of M.

Other procatalysts, especially procatalysts containing other Group IV metal-ligand complexes, will be apparent to those skilled in the art.

The catalyst systems of this disclosure may include co-catalysts or activators in addition to the ionic metallic activator complex having the anion of formula (I) and a countercation. Such additional co-catalysts may include, for example, tri(hydrocarbyl)aluminum compounds having from 1 to 10 carbons in each hydrocarbyl group, an oligomeric or polymeric aluminoxane compound, di(hydrocarbyl)(hydrocarbyloxy)aluminums compound having from 1 to 20 carbons in each hydrocarbyl or hydrocarbyloxy group, or mixtures of the foregoing compounds. These aluminum compounds are usefully employed for their beneficial ability to scavenge impurities such as oxygen, water, and aldehydes from the polymerization mixture.

The di(hydrocarbyl)(hydrocarbyloxy)aluminum compounds that may be used in conjunction with the activators described in this disclosure correspond to the formula T¹₂AlOT² or T¹₁A₁(OT²)₂ wherein T¹ is a secondary or tertiary (C₃-C₆)alkyl, such as isopropyl, isobutyl or tert-butyl; and T² is a alkyl substituted (C₆-C₃₀)aryl radical or aryl substituted (C₁-C₃₀)alkyl radical, such as 2,6-di(tert-butyl)-4-methylphenyl, 2,6-di(tert-butyl)-4-methylphenyl, 2,6di(tert-butyl)-4-methyltolyl, or 4-(3′,5′-di-tert-butyltolyl)-2,6-di-tert-butylphenyl.

Additional examples of aluminum compounds include [C₆]trialkyl aluminum compounds, especially those wherein the alkyl groups are ethyl, propyl, isopropyl, n-butyl, isobutyl, pentyl, neopentyl, or isopentyl, dialkyl(aryloxy)aluminum compounds containing from 1-6 carbons in the alkyl group and from 6 to 18 carbons in the aryl group (especially (3,5-di(t-butyl)-4-methylphenoxy)diisobutylaluminum), methylaluminoxane, modified methylaluminoxane and diisobutylaluminoxane.

In the catalyst systems according to embodiments of this disclosure, the molar ratio of the ionic metallic activator complex to Group IV metal-ligand complex may be from 1:10,000 to 1000:1, such as, for example, from 1:5000 to 100:1, from 1:100 to 100:1 from 1:10 to 10:1, from 1:5 to 1:1, or from 1.25:1 to 1:1 The catalyst systems may include combinations of one or more ionic metallic activator complexes described in this disclosure.

In one or more embodiments, the activator has a solubility of greater than 20 milligrams per milliliter (mg/mL) in methylcyclohexane (MCH) at standard temperature and pressure (STP) (temperature of 22.5±2.5° C. and a pressure of approximately 1 atmosphere). In some embodiments, the activator has a solubility of from 20 to 100 mg/mL in MCH under STP. All individual values and subranges from at least 20 to 100 mg/mL in MCH are included herein and disclosed herein as separate embodiments. For example, any one of the activator according to this disclosure may include at least 21 mg/mL; at least 25 mg/mL, or at least 30 mg/mL in MCH.

In some embodiments the activator has a solubility at 25° C. in hexane, cyclohexane, or methylcyclohexane of at least 1 weight percent. In some embodiments, the activator has a solubility at 25° C. in hexane, cyclohexane, or methylcyclohexane of at least 5 weight percent or at least 8 weight percent.

Solubility of a compound is determined at least in part by entropic effects in the solvent system. The entropic effects may include, for example, changes in lattice energy, solvation, solvent structure, or combinations thereof. Solvation is related to the interactions between a solute (such as an activator or co-catalyst) and molecules of the solvent. Without intending to be bound by theory, the addition of a Lewis base can form a weak adduct with the cation, allowing the positive charge to be further solubilized. This effect can be further promoted by increasing the lipophilicity of the Lewis base component.

Generally, a solute may have similar solubilities in different non-polar solvents. Non-polar solvents generally include hydrocarbon solvents. A non-limiting list of non-polar hydrocarbon solvents include: hexanes, cyclohexane, methylcyclohexane, heptanes, kerosene, toluene, xylenes, turpentine, and ISOPAR-E™ and combinations thereof. In the Example section, the co-catalysts, as described in this disclosure, sufficiently process polymers in a solvent system that includes methylcyclohexane or ISOPAR-E™, both of which are non-polar solvents, and more specifically are hydrocarbon solvents. Therefore, it is believed that the co-catalysts of this disclosure may sufficiently process polymers in other solvent systems.

### Polyolefins

The catalytic systems described in the preceding paragraphs are utilized in the polymerization of olefins, primarily ethylene and propylene, to form ethylene-based polymers or propylene-based polymers. In some embodiments, there is only a single type of olefin or α-olefin in the polymerization scheme, creating a homopolymer. However, additional α-olefins may be incorporated into the polymerization procedure. The additional α-olefin co-monomers typically have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, 1-hexene, and 1-octene; or in the alternative, from the group consisting of 1-hexene and 1-octene.

The ethylene-based polymers, for example homopolymers and/or interpolymers (including copolymers) of ethylene and optionally one or more co-monomers such as α-olefins, may comprise from at least 50 mole percent (mol %) monomer units derived from ethylene. All individual values and subranges encompassed by “from at least 50 mole percent” are disclosed herein as separate embodiments; for example, the ethylene-based polymers, homopolymers and/or interpolymers (including copolymers) of ethylene and optionally one or more co-monomers such as α-olefins may comprise at least 60 mole percent monomer units derived from ethylene; at least 70 mole percent monomer units derived from ethylene; at least 80 mole percent monomer units derived from ethylene; or from 50 to 100 mole percent monomer units derived from ethylene; or from 80 to 100 mole percent monomer units derived from ethylene.

In some embodiments, the polymerization process according to the present disclosure produces ethylene-based polymers. In one or more embodiments, the ethylene-based polymers may comprise at least 90 mole percent units derived from ethylene. All individual values and subranges from at least 90 mole percent are included herein and disclosed herein as separate embodiments. For example, the ethylene-based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments of the ethylene-based polymer, the amount of additional α-olefin is less than 50 mol %; other embodiments include at least 1 mole percent (mol %) to 25 mol %; and in further embodiments the amount of additional α-olefin includes at least 5 mol % to 103 mol %. In some embodiments, the additional α-olefin is 1-octene.

Any conventional polymerization processes may be employed to produce the ethylene-based polymers. Such conventional polymerization processes include, but are not limited to, solution polymerization processes, gas phase polymerization processes, slurry phase polymerization processes, and combinations thereof using one or more conventional reactors such as loop reactors, isothermal reactors, fluidized bed gas phase reactors, stirred tank reactors, batch reactors in parallel, series, or any combinations thereof, for example.

In one embodiment, the ethylene-based polymer may be produced via solution polymerization in a dual reactor system, for example a dual loop reactor system, wherein ethylene and optionally one or more α-olefins are polymerized in the presence of the catalyst system, as described herein, and optionally one or more co-catalysts. In another embodiment, the ethylene-based polymer may be produced via solution polymerization in a dual reactor system, for example a dual loop reactor system, wherein ethylene and optionally one or more α-olefins are polymerized in the presence of the catalyst system in this disclosure, and as described herein, and optionally one or more other catalysts. The catalyst system, as described herein, can be used in the first reactor, or second reactor, optionally in combination with one or more other catalysts. In one embodiment, the ethylene-based polymer may be produced via solution polymerization in a dual reactor system, for example a dual loop reactor system, wherein ethylene and optionally one or more α-olefins are polymerized in the presence of the catalyst system, as described herein, in both reactors.

In another embodiment, the ethylene-based polymer may be produced via solution polymerization in a single reactor system, for example a single loop reactor system, in which ethylene and optionally one or more α-olefins are polymerized in the presence of the catalyst system, as described within this disclosure, and optionally one or more co-catalysts, as described in the preceding paragraphs.

The ethylene-based polymers may further comprise one or more additives. Such additives include, but are not limited to, antistatic agents, color enhancers, dyes, lubricants, pigments, primary antioxidants, secondary antioxidants, processing aids, UV stabilizers, and combinations thereof. The ethylene-based polymers may contain any amounts of additives. The ethylene-based polymers may compromise from about 0 to about 10 percent by the combined weight of such additives, based on the weight of the ethylene-based polymers and the one or more additives. The ethylene-based polymers may further comprise fillers, which may include, but are not limited to, organic or inorganic fillers. The ethylene-based polymers may contain from about 0 to about 20 weight percent fillers such as, for example, calcium carbonate, talc, or Mg(OH)₂, based on the combined weight of the ethylene-based polymers and all additives or fillers. The ethylene-based polymers may further be blended with one or more polymers to form a blend.

In some embodiments, a polymerization process for producing an ethylene-based polymer may include polymerizing ethylene and at least one additional α-olefin in the presence of a catalyst system according to the present disclosure. The polymer resulting from such a catalyst system that incorporates the metal-ligand complex of formula (X) may have a density according to ASTM D792 (incorporated herein by reference in its entirety) from 0.850 g/cm³ to 0.950 g/cm³, from 0.880 g/cm³ to 0.920 g/cm³, from 0.880 g/cm³ to 0.910 g/cm³, or from 0.880 g/cm³ to 0.900 g/cm³, for example.

In another embodiment, the polymer resulting from the catalyst system according to the present disclosure has a melt flow ratio (I₁₀/I₂) from 5 to 15, where the melt index, I₂, is measured according to ASTM D1238 (incorporated herein by reference in its entirety) at 190° C. and 2.16 kg load and melt index I₁₀ is measured according to ASTM D1238 at 190° C. and 10 kg load. In other embodiments the melt flow ratio (I₁₀/I₂) is from 5 to 10, and in others, the melt flow ratio is from 5 to 9.

In some embodiments, the polymer resulting from the catalyst system according to the present disclosure has a molecular-weight distribution (MWD) from 1 to 25, where MWD is defined as M_{w}/Mₙ with M_{w} being a weight-average molecular weight and Mₙ being a number-average molecular weight. In other embodiments, the polymers resulting from the catalyst system have a MWD from 1 to 6. Another embodiment includes a MWD from 1 to 3; and other embodiments include MWD from 1.5 to 2.5.

Embodiments of the catalyst systems described in this disclosure yield unique polymer properties as a result of the high molecular weights of the polymers formed and the amount of the co-monomers incorporated into the polymers.

Procedure for Batch Reactor Polymerization. Raw materials (ethylene, 1-octene) and the process solvent (ISOPAR E) are purified with molecular sieves before introduction into the reaction environment. A stirred autoclave reactor was charged with ISOPAR E, and 1-octene. The reactor was then heated to a temperature and charged with ethylene to reach a pressure. Optionally, hydrogen was also added. The catalyst system was prepared in a drybox under inert atmosphere by mixing the metal-ligand complex and optionally one or more additives, with additional solvent. The catalyst system was then injected into the reactor. The reactor pressure and temperature were kept constant by feeding ethylene during the polymerization and cooling the reactor as needed. After 10 minutes, the ethylene feed was shut off and the solution transferred into a nitrogen-purged resin kettle. The polymer was thoroughly dried in a vacuum oven, and the reactor was thoroughly rinsed with hot ISOPAR E between polymerization runs.

Unless otherwise indicated herein, the following analytical methods are used in describing aspects of the present disclosure:

### Melt Index

Melt indices I₂ (or I2) and I₁₀ (or I10) of polymer samples were measured in accordance to ASTM D-1238 (method B) at 190° C. and at 2.16 kg and 10 kg load, respectively. Their values are reported in g/10 min.

### Density

Samples for density measurement were prepared according to ASTM D4703. Measurements were made, according to ASTM D792, Method B, within one hour of sample pressing.

### Gel Permeation Chromatography (GPC)

The chromatographic system consisted of a PolymerChar GPC-IR (Valencia, Spain) high temperature GPC chromatograph equipped with an internal IR5 infra-red detector (IR5). The autosampler oven compartment was set at 1600 Celsius and the column compartment was set at 1500 Celsius. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)).:

$$M\_polyethylene = A \times ( M\_polystyrene ) \hat{} B \qquad ( EQ 1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * ( ( ( RV\_ ( Peak Max ) / ( Peak Width at 1 / 2 height ) ) \hat{} 2 \qquad ( EQ 2 )$$

where RV is the retention volume in milliliters, the peak width is in milliliters, the peak max is the maximum height of the peak, and 12 height is 12 height of the peak maximum.

$$Symmetry = \frac{( Rear Peak RV \_ ( one tenth height ) - RV \_ ( Peak max ) )}{( {RV}_{Peak max} - Front Peak {RV}_{one tenth height} )} \qquad ( EQ 3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( RV ( F M Calibrated ) / RV ( F M Sample ) )$$

Short chain branching per 1000 total carbon (SCB/1000C) is measured according to method described in the “Molecular Weighted Comonomer Distribution Index (MWCDI)” section of WO2015200743A1.

### General Solubility Test Procedure

Solubility tests are performed at the specified temperature. If not temperature is specified the test was conducted at room temperature (22.5±2.5° C.). The chosen temperature is kept constant in all relevant parts of the equipment. A vial is charged with 30 mg of the co-catalyst (sample) and 1.0 mL of solvent. The suspension of co-catalyst and solvent is stirred for 30 minute at ambient temperature. Then, the mixture is filtered via a syringe filter into a tared vial and the solution is weighed (X g of solution). The solvent is next removed completely under high vacuum and the vial weighed again (Y g of sample). The “ρₛₒₗᵥₑₙₜ” is the density of the solvent in g/mL. The solubility of co-catalyst in solvent was measured in units of mg/mL. The solubility of cocatalyst in solvent was calculated as follows:

$$Solubility = 1000 * Y * \frac{{ρ}_{solvent}}{X - Y} \qquad ( 1 )$$

One or more features of the present disclosure are illustrated in view of the examples as follows:

### EXAMPLES

Example 1 is a synthetic procedures for intermediates and for isolated co-catalysts.

### Example 1—Representative Procedure for Synthesis of Sodium Borate Salts—Synthesis A

In a glove box, magnesium turnings were suspended in diethyl ether and activated by addition of 2 drops of dibromoethane. A bromofluorobenzene compound was slowly added as a 33 wt % solution in diethyl ether. The solution was stirred for 4-6 hours and then was quenched by addition of solid sodium tetrafluoroborate. The quenched solution was stirred for 24 h. The solution was removed from the glovebox and poured into a saturated solution of sodium bicarbonate and stirred for 30 min. The mixture was filtered through celite. The organic solution was isolated and the aqueous solution was extracted with diethyl ether. The combined organic fractions were dried over anhydrous sodium sulfate. The solution was filtered and then concentrated using a rotary evaporator. The resulting residue was re-dissolved in dichloromethane and concentrated using a rotary evaporator. The residue was triturated using dichloromethane yielding an off-white solid and a pale yellow to brown solution. The solid was isolated by filtration, rinsing with additional dichloromethane. The solid was dried under vacuum to yield the desired product.

### Representative Procedure for Synthesis of Sodium Borate Salts—Synthesis B

In a glove box, the desired bromofluorobenzene compound was dissolved in diethyl ether. Isopropyl magnesium chloride in diethyl ether (2M) was then added dropwise. The solution was stirred for 4-6 hours at which point the reaction was quenched by addition of solid sodium tetrafluoroborate. The quenched solution was stirred for 18-24 hours. The solution was removed from the glovebox and poured into a saturated solution of sodium bicarbonate and stirred for 30 min. The organic solution was isolated and the aqueous solution was extracted with diethyl ether. The combined organic fractions were dried over anhydrous sodium sulfate. The solution was filtered and then concentrated using a rotary evaporator. The resulting residue was re-dissolved in dichloromethane and concentrated using a rotary evaporator. The residue was triturated using dichloromethane yielding a white solid and a yellow solution. The solid was isolated by filtration rinsing with additional dichloromethane. The solid was dried under vacuum to yield the desired material.

### Representative Procedure for Cation Exchange to Form Armeenium Borate Salts

Under an inert atmosphere, Armeen HCl and the sodium borate salt were added together in dry, degassed toluene at a 1:1 molar ratio. The suspension was stirred overnight, filtered, and concentrated under vacuum at 50° C. to yield the desired product.

Table 1 tabulates the solubility profiles of Compounds A, B, and C.

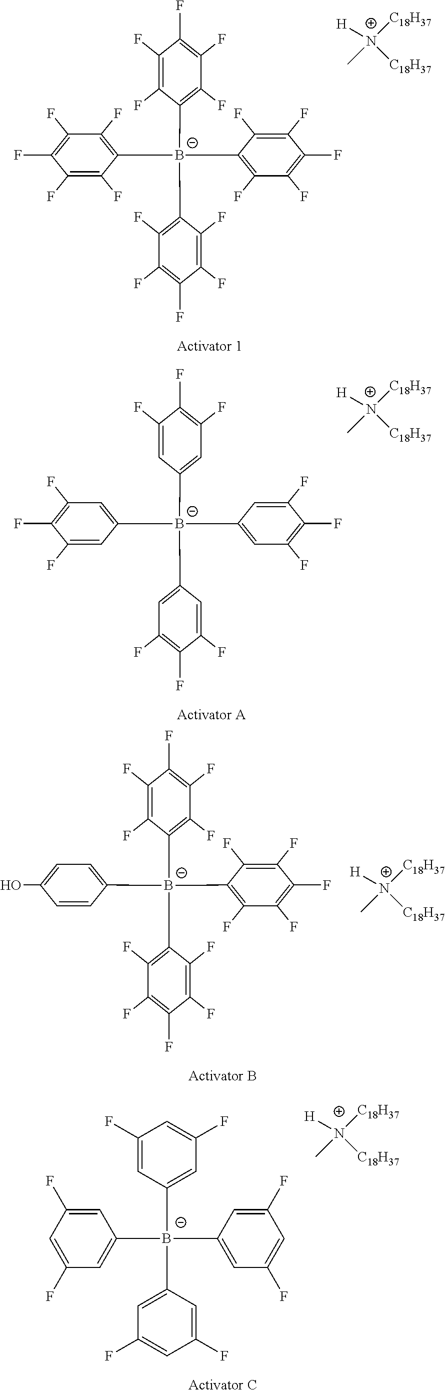

TABLE 1
Solubility table of borate ion pairs

Additive

| Activator | Solvent | Wt % | None | (C₁₈H₃₇)₂NMe |
|---|---|---|---|---|
| A | MCH | 2.7 | biphasic | miscible |
| A | Isopar E | 2.9 | biphasic | miscible |
| A | Hexane | 3.2 | biphasic | miscible |
| B | MCH | 10 | miscible | |
| B | Isopar E | 10 | miscible | |
| B | Hexane | 10 | biphasic | miscible |
| C | MCH | 2.5 | miscible | |
| C | Isopar E | 2.7 | biphasic | miscible |
| C | Hexane | 3.0 | biphasic | miscible |

Ammonium compounds containing long hydrocarbyl chains like the di(n-octadecyl)methylammonium cation improved hydrocarbon solubility. In cases where at least one R group is H, this method commonly produces ionic pairs which phase separate in hydrocarbon solutions. Further, in the comparative system containing tetrakis(pentafluorophenyl)borate, while hydrocarbon solubility is achieved, biphasic behavior can still be observed at lower temperatures, which can cause issues for dispensing or transferring the solution when in low temperature environments. The addition of a Lewis base, like di(n-octadecyl)methylamine, to the catalyst system yields an expanded cation that increases hydrocarbon solubility or increases the range of conditions in which monophasic solutions were obtained and recorded in Table 2. The addition of 0.2 equivalents of the Lewis base, (C₁₈H₃₇)₂NMe to the catalyst system provided a soluble homogeneous solution even at −35° C.

TABLE 2
Solution Composition of [H(C₁₈H₃₇)₂NMe][B(C₆F₅)₄]
(Activator 1) in methylcyclohexane

| | | Additive | | |
|---|---|---|---|---|
| Temperature | | | (C₁₈H₃₇)₂NMe | (C₁₈H₃₇)₂NMe |
| (° C.) | Wt % | None | (1 equiv) | (0.2 equiv) |
| 0 | 10 | Soluble | Soluble | Soluble |
| −35 | 10 | Gel | White-Precipitate | Soluble |

TABLE 3
Solution Composition of [H(C₁₈H₃₇)₂NMe][B(C₆H₃(CF₃)₂)₄]
in n-hexane

| | | Additive | | |
|---|---|---|---|---|
| Temperature | | | (C₁₈H₃₇)₂NMe | (C₁₈H₃₇)₂NMe |
| (° C.) | Wt % | None | (1 equiv) | (0.2 equiv) |
| −35 | 10 | Biphasic | White-Precipitate | Soluble |

Storing and transportation may require cooler temperature. While solubility may be acceptable at room temperature, lower temperatures may lower the solubility of components, and in extreme cases, may even result in biphasic mixtures. By increasing the solubility of the compound, there is less likelihood of the solution becoming biphasic. The solubility data tabulated in Tables 2 and 3 indicate that the activator complexes that include an activator and a Lewis base are soluble at very low temperatures.

All manipulations of air-sensitive materials were performed with rigorous exclusion of O₂ and moisture in oven-dried Schlenk-type glassware on a dual manifold Schlenk line, interfaced to a high-vacuum line (10⁻⁶ Torr), or in a N₂-filled MBraun glove box with a high-capacity recirculator (less than 1 ppm O₂). Argon (Airgas, pre-purified grade) was purified by passage through a supported MnO oxygen-removal column and an activated Davison 4A molecular sieve column. Ethylene (Airgas) was purified by passage through an oxygen/moisture trap (Matheson, model MTRP-0042-XX). Hydrocarbon solvents (n-pentane, n-hexane, 1-hexene, methylcyclohexane, and toluene) were dried using activated alumina columns according to the method described by Grubbs (see Pangborn, A. B.; Giardello, M. A.; Grubbs, R. H.; Rosen, R. K.; Timmers, F. J., Safe and Convenient Procedure for Solvent Purification. Organometallics 1996, 15 (5), 1518-1520.) and were then vacuum-transferred from Na/K alloy. Benzene-d6 and toluene-d8 (Cambridge Isotope Laboratories, 99+ atom % D) were stored over Na/K alloy in vacuum and vacuum-transferred immediately prior to use. 1,2-Difluorobenzene and chlorobenzene-d5 were dried with CaH₂, distilled under vacuum. Chloroform-d3 and 1,1,2,2-tetrachloroethane-d2 were used as received (Cambridge Isotope Laboratories, 99+ atom % D).

### Equipment Standards

All solvents and reagents are obtained from commercial sources and used as received unless otherwise noted. Anhydrous toluene, hexanes, tetrahydrofuran, and diethyl ether are purified via passage through activated alumina and, in some cases, Q-5 reactant. Solvents used for experiments performed in a nitrogen-filled glovebox are further dried by storage over activated 4 Å molecular sieves. Glassware for moisture-sensitive reactions is dried in an oven overnight prior to use. NMR spectra are recorded on Varian 400-MR and VNMRS-500 spectrometers. LC-MS analyses are performed using a Waters e2695 Separations Module coupled with a Waters 2424 ELS detector, a Waters 2998 PDA detector, and a Waters 3100 ESI mass detector. LC-MS separations are performed on an XBridge C18 3.5 m 2.1×50 mm column using a 5:95 to 100:0 acetonitrile to water gradient with 0.1% formic acid as the ionizing agent. IRMS analyses are performed using an Agilent 1290 Infinity LC with a Zorbax Eclipse Plus C18 1.8 m 2.1×50 mm column coupled with an Agilent 6230 TOF Mass Spectrometer with electrospray ionization. ¹H NMR data are reported as follows: chemical shift (multiplicity (br=broad, s=singlet, d=doublet, t=triplet, q=quartet, p=pentet, sex=sextet, sept=septet and m=multiplet), integration, and assignment). Chemical shifts for ¹H NMR data are reported in ppm downfield from internal tetramethylsilane (TMS, 6 scale) using residual protons in the deuterated solvent as references. ¹³C NMR data are determined with ¹H decoupling, and the chemical shifts are reported downfield from tetramethylsilane (TMS, 6 scale) in ppm versus the using residual carbons in the deuterated solvent as references.

1. An activator complex comprising a Lewis base and an activator, wherein the activator comprises an anion and a cation, the anion having a structure according to formula (I): 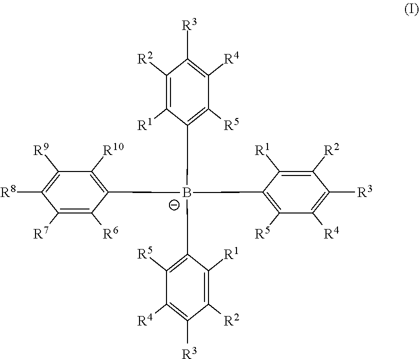
where:
B is boron atom;
each R¹ and each R⁵ is selected from —H or —F;
each R², R³, and R⁴ is selected from —H, —F, (C₁-C₁₀)hydrocarbyl, (C₁-C₁₀)heterohydrocarbyl, and optionally R³ and R⁴ are connected to form a ring; provided that at least one of R¹, R², R³, R⁴, and R⁵ is fluorine atom;
R⁶, R⁷, R⁸, R⁹, and R¹⁰ are independently selected from —H, —F, (C₁-C₁₀)hydrocarbyl, (C₁-C₁₀)heterohydrocarbyl, —OR^{C}, —SiR^{C}₃, wherein R^{C} is —H or (C₁-C₁₀)hydrocarbyl, and optionally R⁷ and R⁸ are connected to form a ring;
wherein the Lewis Base has a structure according to formula (II):
M₂R^{N1}R^{N2}R^{N3} (II)
where:
M₂ is nitrogen or phosphorous; and
R^{N1} is (C₁-C₃₀)hydrocarbyl, R^{N2} is (C₂-C₃₀)hydrocarbyl, and R^{N3} is (C₂-C₃₀)hydrocarbyl.

2. The activator complex of claim 1, wherein when three or more of R⁶, R⁷, R⁸, R⁹, and R¹⁰ are fluorine atoms, at least one of R¹, R², R³, R⁴, and R⁵ of each individual ring is a —H.

3. The activator complex of claim 1, wherein when none of R⁶, R⁷, R⁸, R⁹, and R¹⁰ are fluorine atoms, at least four of R¹, R², R³, R⁴, and R⁵ are fluorine atoms.

4. The activator complex of claim 1, wherein the catalyst system comprises less than 1.0 molar equivalent of the Lewis Base based on the molar amount of the activator.

5. The activator complex of claim 1, wherein the catalyst system comprises a molar ratio of the Lewis base to the activator of 0.9:1 to 0.01:1, or from 0.05:1 to 0.01:1.

6. (canceled)

7. The activator complex of claim 1, wherein the activator is dissolved in a hydrocarbon solvent in which the weight percent of the Lewis base is greater than 10 ppm, greater than 100 ppm, or greater than 1000 ppm.

8. (canceled)

9. (canceled)

10. The activator complex of claim 1, wherein the cation comprises the protonated structure of formula (II).

11. The activator complex of claim 1, wherein the activator has a solubility at 25° C. in hexane, cyclohexane, or methylcyclohexane of at least 1 weight percent, at least 5 weight percent, or at least 8 weight percent.

12. (canceled)

13. (canceled)

14. The activator complex of claim 1, wherein the total number of fluorine atoms is at least 4 or from 4 to 18.

15. (canceled)

16. A catalyst system comprising a procatalyst and the activator complex according to claim 1.

17. A catalyst system comprising a metal-ligand complex procatalyst, a Lewis base, and an activator, wherein the activator is selected from:

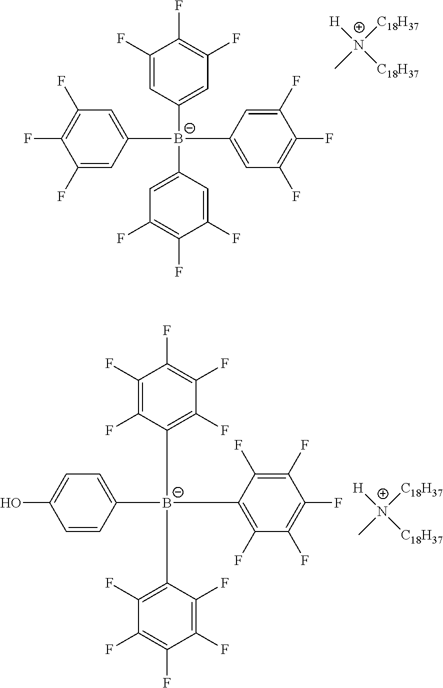

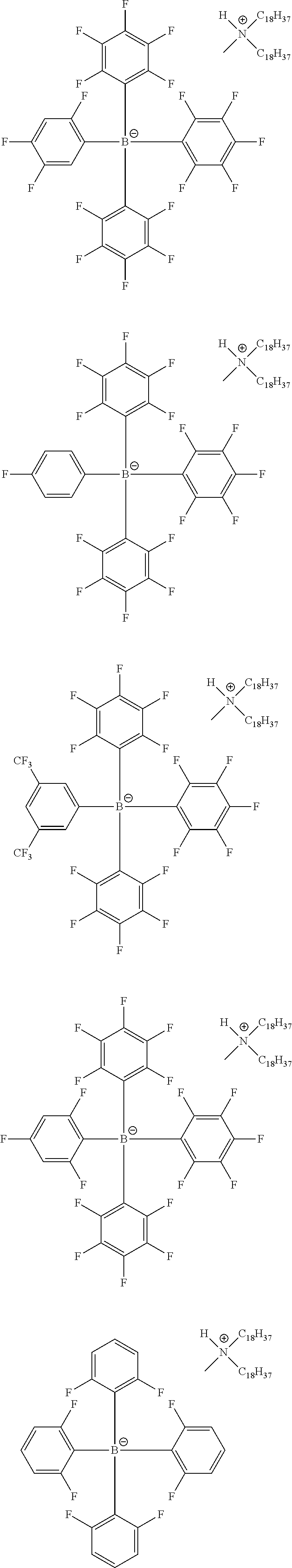

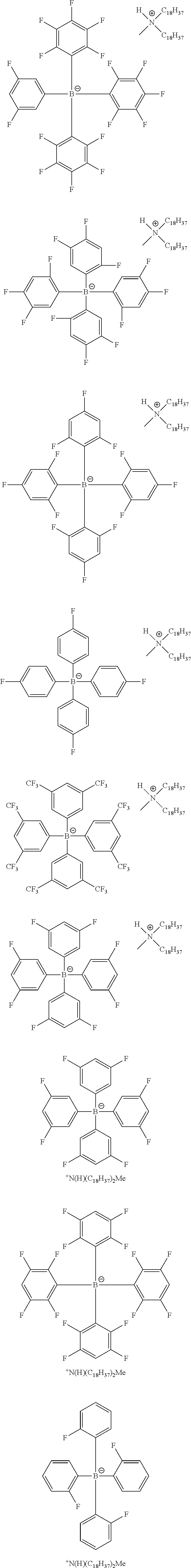

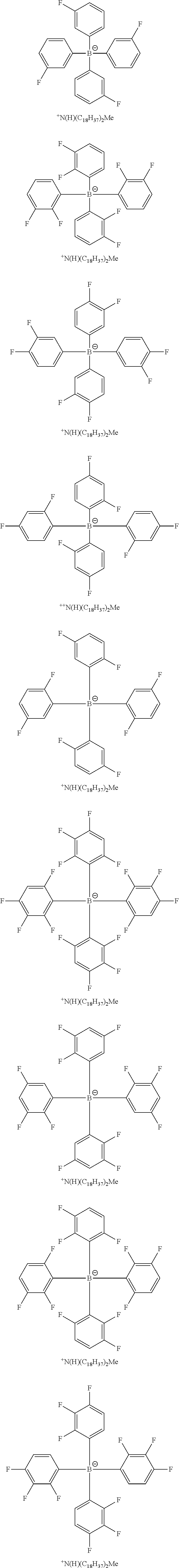

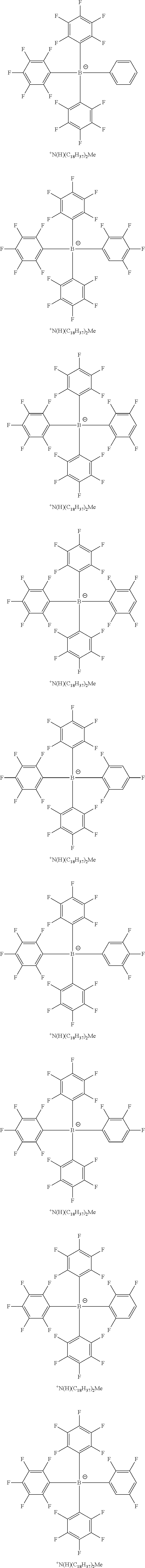

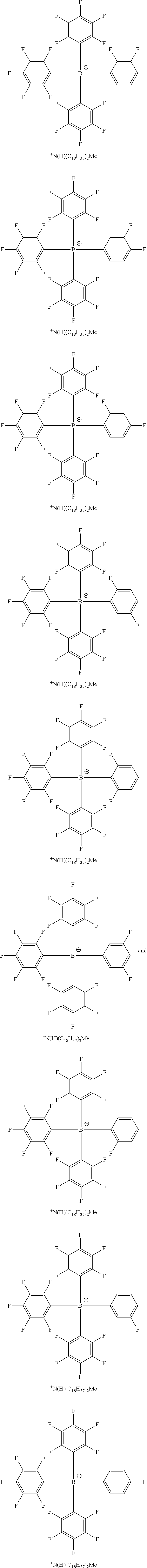

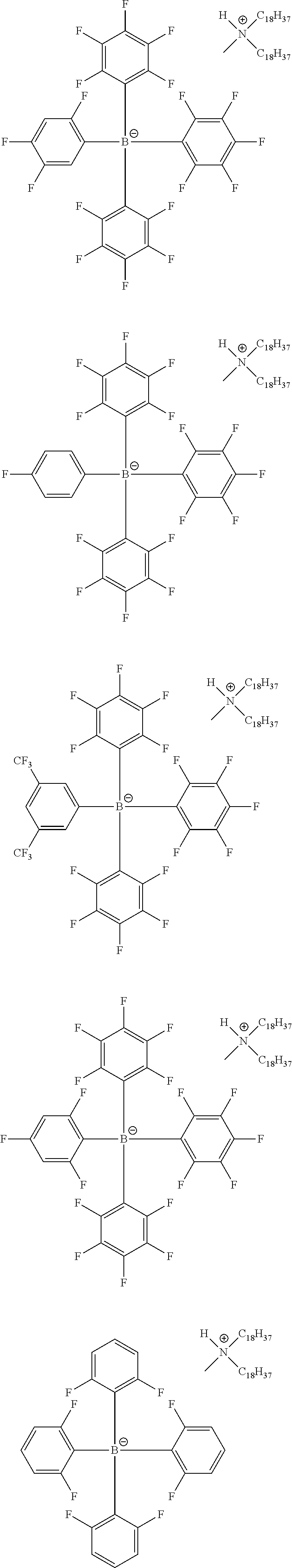

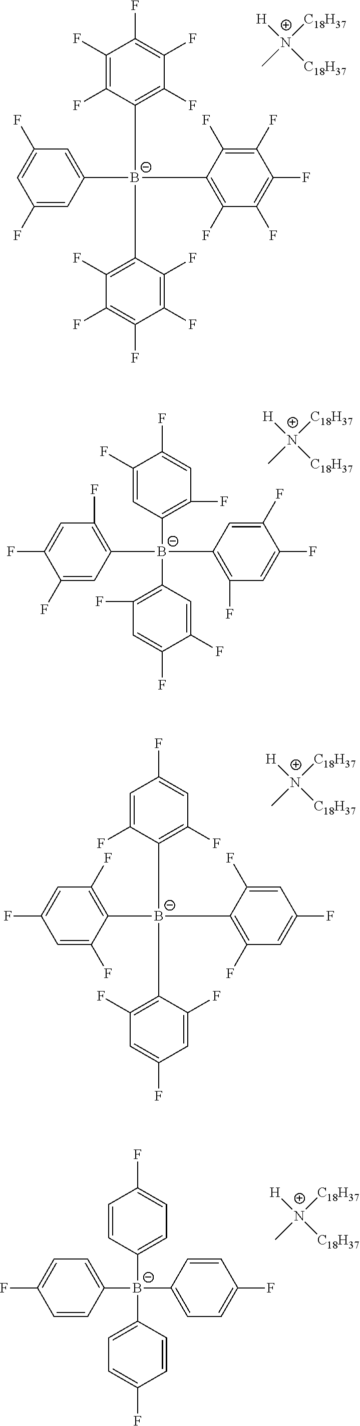

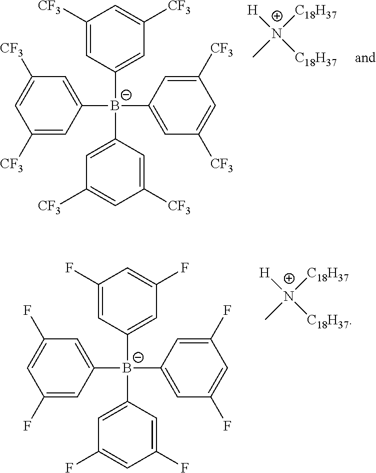

18. The catalyst system of claim 17, wherein the procatalyst is a metal-ligand complex.

19. The catalyst system of claim 17, wherein the procatalyst is a bis(phenylphenoxy) metal-ligand complex.
